(19) United States
(12) Patent Application Publication
(10) Pub. No.: US 2019/0012067 A1
(43) Pub. Date: Jan. 10, 2019

(54) IMAGE DISPLAYING APPARATUS, IMAGE DISPLAY METHOD, AND STORAGE MEDIUM

(71) Applicant: CANON KABUSHIKI KAISHA, Tokyo (JP)

(72) Inventors: Masahiro Yakami, Kyoto-shi (JP); Yutaka Emoto, Kyoto-shi (JP); Thai Akasaka, Kyoto-shi (JP); Gakuya Soeda, Isehara-shi (JP); Kiyohide Satoh, Kawasaki-shi (JP); Ryo Ishikawa, Kawasaki-shi (JP)

(21) Appl. No.: 16/030,019

(22) Filed: Jul. 9, 2018

(30) Foreign Application Priority Data
Jul. 10, 2017 (JP) 2017-134689
Jul. 4, 2018 (JP) 2018-127501

(51) Int. Cl. G06F 3/0484; G06F 3/0481

(52) U.S. Cl. CPC G06F 3/04845; G06F 3/0481

(57) ABSTRACT

The image displaying apparatus includes: an image acquiring unit configured to acquire an object image to be displayed; a determining unit configured to determine whether the object image to be displayed is a predetermined display type, a reference value of which is allocated to a particular pixel value; a setting unit configured to set the WL and the WW when the object image to be displayed is displayed and fix the WL to a predetermined value when the determining unit determines that the object image to be displayed is a predetermined display type; and an image converting unit configured to convert the object image to be displayed so that the object image to be displayed is displayed at the WL fixed to the predetermined value or the set WL and with the set WW.

### BACKGROUND OF THE INVENTION

### Field of the Invention

The present invention relates to an image displaying apparatus, an image displaying method, and a storage medium.

### Description of the Related Art

For example, in the medical field, doctors perform diagnosis by observing images captured by various kinds of image capturing apparatuses (modalities). Such an image usually has gradation exceeding the display capability of a monitor and the visual recognition capability of a human being. Thus, an image displaying apparatus configured to handle the image typically has the window function of specifying, as a display parameter, the range (window) of pixel values to be displayed and mapping any pixel value in the range to a display value (display luminance value) on the monitor.

Japanese Patent Application Laid-Open No. 2008-11935 discloses a well-known window function of setting the range of pixel values to be displayed with two parameters of a window level (hereinafter referred to as WL) indicating a pixel value at the center of the range and a window width (hereinafter referred to as WW) indicating the width of the range. An image displaying apparatus having such a window function also has, for example, a manual adjustment function of changing the WL and the WW simultaneously through up, down, right, and left drag operations of a mouse, and an automatic adjustment function of calculating and adjusting the WL and the WW simultaneously based on a distribution of pixel values in an image. The image displaying apparatus allows diagnosis to be performed while a site or an organ desired to be observed is clearly displayed by adjusting the WL and the WW.

Comparison of a plurality of images is performed by observing an image obtained by allocating each difference or change amount between the images to a pixel value in some cases. For example, two images to be compared are positioned to perform observation of an image (hereinafter referred to as a difference image) obtained from a pixel value difference between corresponding pixels (voxels) in the images, or an image (hereinafter referred to as a Jacobian map) obtained from the ratio of local volumes in the images in some cases. Typically in such an image obtained from the difference or change amount between images, a state (the difference image has a difference amount of zero or the Jacobian map has a volume ratio of one) in which no difference nor change exists between the images is used as a reference, a value (reference value) representing the reference is allocated to a particular pixel value. Then, image observation is performed based on the difference from the reference value. Typically, the WL and WW of such an image, the reference value of which is allocated to a particular pixel value can be adjusted.

### SUMMARY OF THE INVENTION

To solve the above-described problem, an image displaying apparatus according to an aspect of the present invention includes: an image acquiring unit configured to acquire an object image to be displayed; a determining unit configured to determine whether the object image to be displayed is a predetermined display type, a reference value of which is allocated to a particular pixel value; a setting unit configured to set a window level and a window width for displaying the object image to be displayed and fix the window level to a predetermined value when the determining unit determines that the object image to be displayed is the predetermined display type; and an image converting unit configured to convert the object image to be displayed so that the object image to be displayed is displayed with the window level fixed to the predetermined value or the set window level and with the set window width.

Further features of the present invention will become apparent from the following description of exemplary embodiments with reference to the attached drawings.

### BRIEF DESCRIPTION OF THE DRAWINGS

FIG. 1 is an entire configuration diagram of an image display system including an image displaying apparatus according to a first embodiment of the present invention.

FIG. 2 is a flowchart illustrating the procedure of processing executed by a control unit at image display in the first embodiment.

FIG. 3 is a diagram exemplarily illustrating a GUI for setting a WL and a WW in a “WL adjustment permit mode” and a “WL adjustment inhibit mode”.

FIG. 4 is a diagram illustrating exemplary conversion from a normal pixel value to a display value by a window function.

FIG. 5 is a diagram exemplarily illustrating the relation between each of a normal image, a difference image, and a Jacobian map and the histogram thereof.

FIG. 6 is a diagram illustrating an exemplary display type specification UI in a third embodiment.

FIG. 7 is a diagram illustrating an exemplary WL/WW parameter selection UI in the third embodiment.

FIG. 8 is a diagram illustrating exemplary conversion from a pixel value to a display value in a fourth embodiment.

FIG. 9 is a diagram illustrating exemplary conversion from a pixel value to a display value in the fourth embodiment.

FIG. 10 is a diagram for description of exemplary conversion from a pixel value to a display value at typical WL/WW automatic adjustment.

FIG. 11 is a diagram illustrating exemplary conversion from a pixel value to a display value at WL/WW automatic adjustment in a fifth embodiment.

FIG. 12 is a diagram illustrating exemplary conversion from a pixel value to a display value at WL/WW automatic adjustment in a modification of the fifth embodiment.

FIG. 13 is a diagram illustrating an exemplary mouse cursor in the first modification of the first embodiment.

FIG. 14 is a diagram illustrating another exemplary mouse cursor in the first modification of the first embodiment.

### DESCRIPTION OF THE EMBODIMENTS

Preferred embodiments of the present invention will now be described in detail in accordance with the accompanying drawings.

In a disclosed method such as Embodiment 5 (refer to paragraph [0090]) disclosed in Japanese Patent Application Laid-Open No. 2008-11935, at least one of the WL and the WW is adjusted through a single movement or operation of sliding a finger or the like in contact with a screen in a particular direction. According to this method, the WL and the WW can be adjusted through a simple operation to easily obtain an image suitable for observation. However, in this method, for example, the WL is potentially changed despite of intention to adjust only the WW, depending on the way of sliding a finger. For example, appropriate diagnosis is potentially hindered when the WL is unintentionally changed at display of an image such as a difference image, the reference value of which is allocated to a particular pixel value.

The present invention is intended to solve the above-described problem by preventing unintentional change of the WL when an image, the reference value of which is allocated to a particular pixel value is displayed in, for example, an image displaying apparatus capable of adjusting the WL and the WW through a single or identical operation.

Exemplary embodiments of the present invention will be described below in detail with reference to the accompanying drawings. However, dimensions, materials, shapes, relative disposition of components, and the like described below in the embodiments are optional and may be changed in accordance with the configuration of an apparatus to which the present invention is applied or various conditions. In the drawings, any elements identical or functionally similar to each other are denoted by an identical reference sign.

### First Embodiment

An image displaying apparatus according to a first embodiment of the present invention displays three-dimensional and two-dimensional images. The apparatus has the window function of adjusting the above-described window level (WL) and window width (WW) at conversion from a pixel value to a display value. The WL can be appropriately controlled at display of an image such as a difference image or a Jacobian map, the reference value of which is allocated to a particular pixel value. In addition, display parameters can be easily set at display of an image, the reference value of which is allocated to a particular pixel value, on an image viewer.

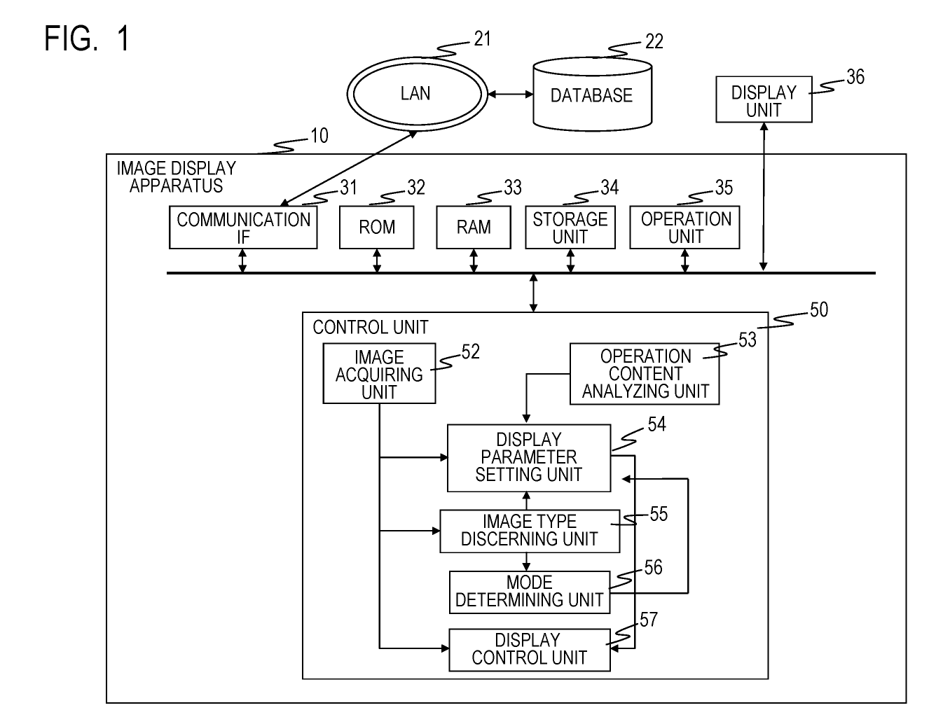

FIG. 1 is a diagram illustrating the entire configuration of an image display system including the image displaying apparatus according to the first embodiment of the present invention. The image display system includes this image displaying apparatus 10, a database 22, and a display unit 36. That is, the image displaying apparatus 10 of one aspect of the present invention for changing over or converting a display mode to a predetermined display mode as described below so as to create an image to be displayed on a screen of the display unit 36. The image displaying apparatus 10 and the database 22 are connected with each other through a communication unit 21 to perform communication therebetween. In the present embodiment, the communication unit 21 is achieved by a local area network (LAN).

The database 22 stores and manages data such as various images to be described later. The image displaying apparatus 10 acquires an image managed in the database 22 through the communication unit 21 exemplified by a LAN. The display unit 36 is achieved by, for example, a display and displays various kinds of information to a user. The image displaying apparatus 10 and the display unit 36 are connected with each other through a communication unit (not illustrated) or a display cable (not illustrated). In this example, the image displaying apparatus 10, the database 22, and the display unit 36 are independent from each other, but may be entirely or partially integrated with each other. The database 22 may be replaced with an image capturing apparatus, and the image displaying apparatus may directly convert captured image data into an image.

The image displaying apparatus 10 includes, as functional components, a communication interface (IF) 31, a read only memory (ROM) 32, a random access memory (RAM) 33, a storage unit 34, an operation unit 35, and a control unit 50. The communication IF 31 is achieved by, for example, a LAN card, and governs communication between an external apparatus (for example, the database 22) and the image displaying apparatus 10. The ROM 32 is achieved by, for example, a non-transitory memory and stores various computer programs and the like. The RAM 33 is achieved by, for example, a transitory memory, and temporarily stores various kinds of information. The storage unit 34 is achieved by, for example, a hard disk drive (HDD), and stores various kinds of information. The operation unit 35 is achieved by, for example, a keyboard and a mouse, and inputs an instruction from the user to the apparatus. The control unit 50 is achieved by, for example, a central processing unit (CPU), and performs overall control processing at the image displaying apparatus 10. In this example, all exemplarily illustrated functional components are included in the image displaying apparatus 10, but may be all or partially independent from each other. The operation unit 35 may be integrated with the display unit 36 so that all inputs to the image displaying apparatus 10 by the user are performed in a GUI format.

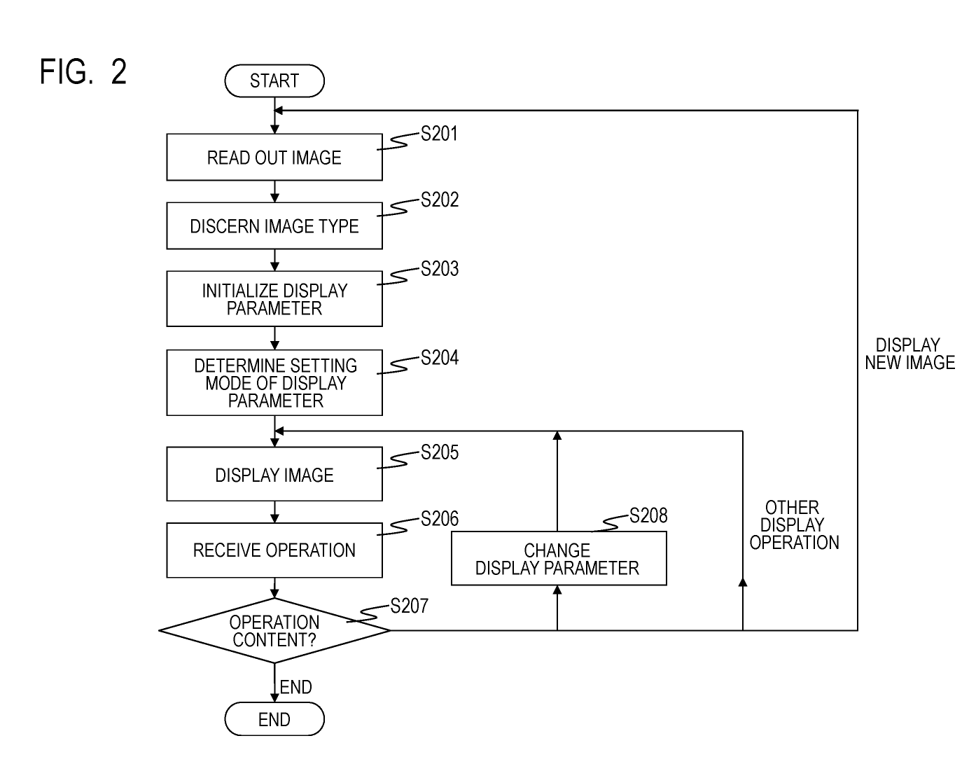

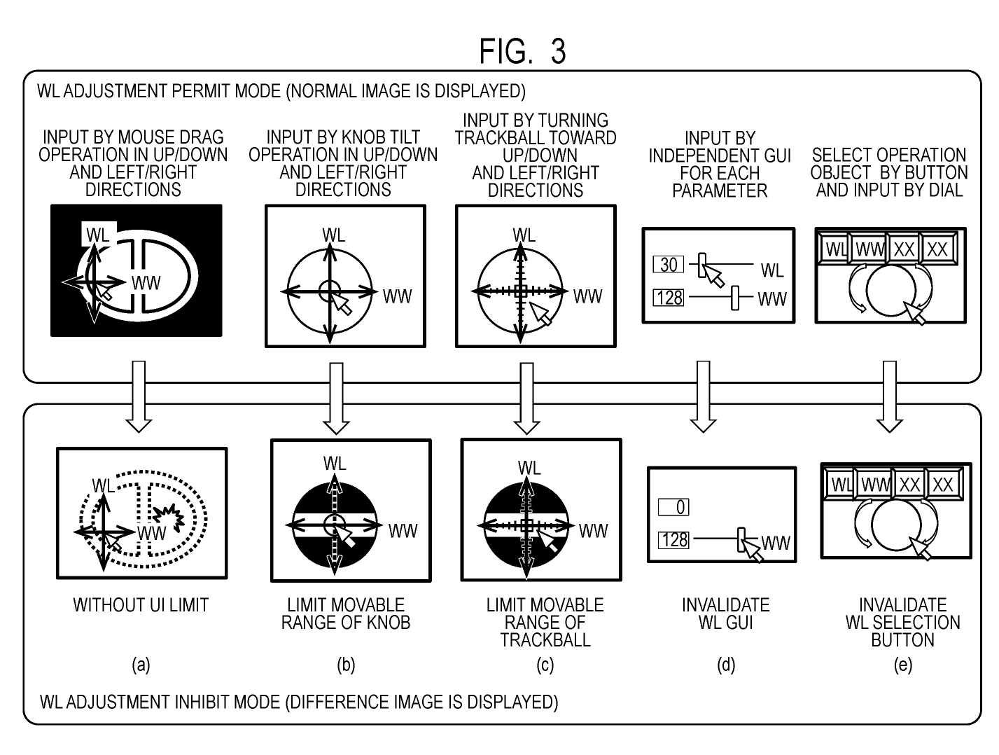

The control unit 50 includes, as functional components, an image acquiring unit 52, an operation content analyzing unit 53, a display parameter setting unit 54, a display type determining unit 55, a mode determining unit 56, and a display control unit 57. The functionalities of the components in the control unit 50 will be described with reference to flowcharts illustrated in FIGS. 2 and 3. FIG. 2 is a flowchart illustrating the procedure of processing executed by the control unit 50 of the image displaying apparatus 10 at image display in the first embodiment of the present invention.

FIG. 2 only illustrates the procedure of processing related to display image adjustment through the window function in the processing of displaying a typical image or an image, the reference value of which is allocated to a particular pixel value. Although there are a large number of other kinds of control (processing) performed by the control unit 50 and user inputting related to the control, the following only describes typical examples thereof to facilitate understanding, and omits description of the others. In the present embodiment, an object image to be displayed is an image to which a header for determining a display type is written or added.

When the image display processing is started, at step S201, the image acquiring unit 52 reads, as an object image to be displayed, an image specified by the user through the operation unit 35 from the database 22 or the storage unit 34.

At step S202, the display type determining unit 55 determines the display type of the object image to be displayed that is read at step S201. Specifically, whether the image is, for example, a CT image, an MRI image, or a difference image is determined. In the present embodiment, this image determination is performed by analyzing the header of the object image to be displayed to acquire information on a display type added as the header to the image. For example, when the header of the read image includes a flag (subtraction flag) indicating a difference image, the image is determined to be a difference image. Information indicating what kind of image the object image to be displayed is not limited to the format as a header but may be any format readable by the display type determining unit 55. For Example, the display type determining unit 55 may determines the display type based on a position of a cursor of a mouse in a case that the display position on the screen is previously determined in accordance with the display type of the image. That is, the display type determining unit 55 may determines a kind of the medical image based on the position of an index capable of being moved by the user in the display unit.

At step S203, the display parameter setting unit 54 sets initial values (initial WW and initial WL) of display parameters for displaying the object image to be displayed that is read at step S201. In the present embodiment, display parameters (WL and WW values) recorded in the header of the object image to be displayed are acquired and set as the WL and the WW for image display.

In this example, the display parameters are recorded in the header, but for example, display parameters predetermined for each display type may be set based on the display type of the object image to be displayed, which is determined at step S202. Alternatively, when display parameters are recorded in the header, the values thereof may be set as initial values as described above, or when no display parameters are recorded in the header, initial values stored for the display type in, for example, the storage unit 34 may be read and set.

When the display type is a kind of an “image, the reference value of which is allocated to a particular pixel value”, it is desirable to set a pixel value corresponding to the reference value as the initial value of the WL. For example, when the display type indicates a difference image, it is desirable that the WL is zero because any display parameter is preferably set by using, as a reference, its value when a difference is zero. The following describes reading of a difference image as an exemplary image generated by allocating the reference value to a particular pixel value.

At step S204, the mode determining unit 56 determines the setting mode of display parameters in accordance with whether the read object image to be displayed is a difference image. Specifically, when the object image to be displayed is a difference image, the setting mode of display parameters is determined to be a “WL adjustment inhibit (invalidate) mode” so that adjustment of the WL is inhibited (invalidated) in any following “operation related to window adjustment”. Otherwise, the setting mode of display parameters is determined to be a “WL adjustment permit (validate) mode” so that adjustment of the WL is permitted in any following “operation related to window adjustment”. The display control unit 57 controls, in accordance with the setting mode of display parameters determined by the mode determining unit 56, the display unit 36 to display a GUI (hereinafter referred to as a WL adjustment and WW adjustment UI) for adjusting display parameters.

FIG. 3 illustrates an exemplary WL adjustment and WW adjustment UI displayed on the display unit 36 by the display control unit 57. The following describes five examples illustrated in Sections (a) to (e) of FIG. 3.

Section (a) of FIG. 3 illustrates an exemplary UI with which the WL and the WW are adjusted through a mouse drag operation in two-dimensional directions on an image displayed on the display unit 36. This UI does not change between the “WL adjustment permit mode” and the “WL adjustment inhibit mode”. In the present example, WL adjustment inhibiting processing is executed by the display parameter setting unit 54 at, for example, step S208 to be described later. With this UI, change of the WL is instructed through a mouse drag operation in the up/downward direction, and change of the WW is instructed through a mouse drag operation in the left/right direction. A mouse is movable on the image simultaneously in the up, down, right, and left directions (in an oblique direction). When an operation in an oblique direction is performed, the instruction for change of the WL and the instruction for change of the WW are simultaneously acquired. The UI for handling a mouse drag operation is not limited to the above-described UI, but the UI may be changed depending on a mode.

Section (b) of FIG. 3 illustrates an example in which a GUI representing a “knob” is displayed on the display unit 36 and the WL and the WW are changed through the GUI. Section (c) of FIG. 3 illustrates an example in which a GUI representing a “truck ball” is displayed on the display unit 36 and the WL and the WW are changed through the GUI. In any of the examples, change of the WL is instructed through an operation on the GUI in the up/downward direction, and change of the WW is instructed through an operation on the GUI in the left/right direction. When the setting mode of display parameters is the “WL adjustment permit mode”, the display control unit 57 controls the display unit 36 to display these GUIs while allowing a two-dimensional operation thereon. Specifically, the “knob” and the “truck ball” are allowed to move in the up/downward direction, the left/right direction, and an oblique direction as a mixture of the up/downward and left/right directions. When the setting mode of display parameters is the “WL adjustment inhibit mode”, the display control unit 57 controls the display unit 36 to display these GUIs while allowing an operation thereon only in the left/right direction. Specifically, in the WL adjustment inhibit mode, the “knob” and the “truck ball” are not allowed to be operated in the up/downward direction nor an oblique direction. Accordingly, the user can be prevented from wrongly changing the WL at difference image display. This configuration of not allowing an operation is merely exemplary. For example, an operation may be allowed but not reflected on adjustment of the WL.

Sections (d) and (e) of FIG. 3 illustrate exemplary GUIs with which the WL and the WW are adjusted through independent parts. Section (d) of FIG. 3 illustrates an example in which the display unit 36 displays a GUI that displays a slider bar for setting the value of each display parameter and a numerical value inputting box on which a value is directly input. Section (e) of FIG. 3 illustrates an example in which the display unit 36 displays a GUI with which a display parameter to be operated is selected through a button and the value thereof is changed through a common dial. When these GUIs are used, the display control unit 57 temporarily invalidates the part for the WL when the setting mode of display parameters is the “WL adjustment inhibit mode”. Accordingly, the user can be prevented from wrongly changing the WL. Any above-described UI or GUI is merely exemplary and may be modified in various manners in accordance with an allowed display size, a display image, and the like, or may be any well-known UI.

At step S205, the display control unit 57 generates a display image by converting each pixel value in the object image to be displayed into a display value by using the display parameters (WL and WW) set at step S203 and step S208 to be described later. Then, the display control unit 57 controls the display unit 36 to display the generated display image. The above-described GUI or the like is displayed together with the generated display image.

Steps S206 to S208 perform processing corresponding to a user operation after the image display. At step S206, the operation content analyzing unit 53 receives an operation performed by the user through the operation unit 35. In the present embodiment, the received operation includes an operation related to window adjustment through a GUI illustrated in at least FIG. 3, and any other operation. The other operation includes, for example, a display operation other than an operation related to window adjustment, an operation of switching object images to be displayed, and an operation of instructing end of entire processing, which are allowed by a typical image displaying apparatus.

When an operation related to window adjustment is received at step S206, the operation content analyzing unit 53 acquires information related to window adjustment from the operation. Specifically, change amounts (values added to the currently set values) of the WL and the WW or specified WL and WW values are acquired as the information related to window adjustment in accordance with the kind of a GUI exemplarily described above. The acquired information is transmitted to the display parameter setting unit 54.

At step S207, the operation content analyzing unit 53 calls processing in accordance with the content of the operation. For example, when an operation related to window adjustment is received, the processing proceeds to step S208. When an operation related to new file display is received, the processing returns to step S201 again, and a new object image to be displayed is read. When an instruction to end the processing is received, the entire processing is ended. When an instruction for any other display operation is received, the processing returns to step S205. At step S205, the display control unit 57 applies the contents of various operations, generates a display image from the object image to be displayed, and controls the display unit 36 to display the display image. Basic functions of an image displaying apparatus, such as slice switching, scaling up and down, and translation are achieved by applying an instruction for any other display operation in this manner.

At step S208, the display parameter setting unit 54 updates set values of the WL and the WW based on the information related to window adjustment that is acquired at step S206. As described above, for example, when the values of the WL and the WW are acquired as the information related to window adjustment, these values are used as new set values of the WL and the WW. When the change amounts of the WL and the WW are acquired as the information related to window adjustment, these values are, for example, added to the currently set values of the WL and the WW, and values obtained through the addition are used as new set values. When the setting mode of display parameters is the “WL adjustment inhibit mode” and a GUI that allows an operation of the WL, such as an UI with which the WL and the WW are adjusted through a mouse drag operation in a two-dimensional direction, is used, any operation of the WL at the present step is prevented. In other words, the currently set value of the WL is not changed when the change amount of the WL is specified. Then, only the set value of the WW is updated, and the processing proceeds to step S205.

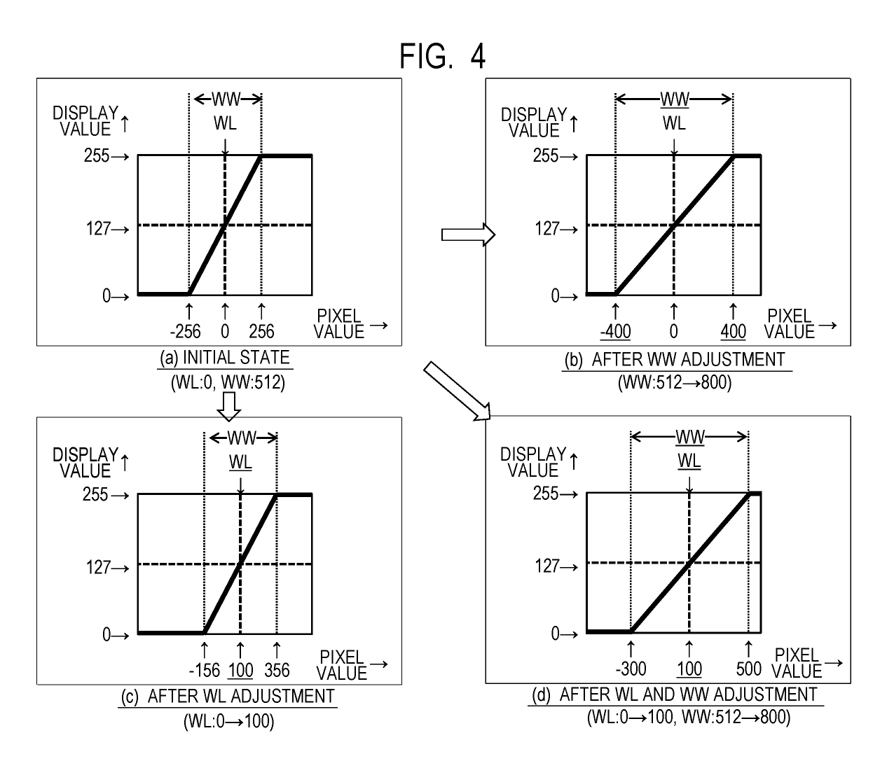

FIG. 4 illustrates exemplary results of adjusting the WL and the WW of a difference image. FIG. 4 is a diagram for description of a mapping function for allocating each pixel value of a difference image as an object image to be displayed to a pixel value (display value) of a display image. In FIG. 4, the horizontal axis represents the pixel value of the difference image as an object image to be displayed, and the vertical axis represents the pixel value (display value) of the display image. In Section (a) of FIG. 4 as an initial state at image display, the pixel value of zero as the reference value of the difference image is allocated to the central value of 127 of the display value. In other words, the WL is set to be zero. In a typical UI with which WL adjustment is validated, an image displayed through adjustment of the WW and the WL can freely transition to states illustrated in Sections (b) to (d) of FIG. 4.

When adjustment of increasing only the WW is performed, for example, the window range (range of pixel values to be displayed) of −256 to +256 is changed to −400 to +400 as illustrated in Section (b) of FIG. 4. However, since the WL is not adjusted, the pixel value of zero is still allocated to the central value of 127 of the display value. When only the WL is adjusted, the window range of −256 to +256 is changed to, for example, −156 to +356 as illustrated in Section (c) of FIG. 4. In other words, the width of pixel values to be displayed is not changed. However, since the WL is adjusted, the pixel value of 100 is allocated to the central value of 127 of the display value. When the adjustment of the WW and the WL illustrated in Sections (b) and (c) of FIG. 4 is simultaneously performed, the window range is changed to −300 to +500 and the pixel value of 100 is allocated to the central value of 127 of the display value as illustrated in Section (d) of FIG. 4.

However, when the object image to be displayed is a difference image, for example, a reference value needs to be constantly indicated by a particular display value to perform observation with respect to “no difference”. In this example, the pixel value of zero as a reference value needs to be constantly allocated to the central value of 127 of the display value. Specifically, as described above, the display value for the reference value is preferably maintained when any display parameter is changed in observation of a difference image, and thus WL adjustment is an excess function. Transition to Sections (c) and (d) of FIG. 4 at display of the difference image can be prevented by inhibiting or invalidating WL adjustment through the mode selection at step S204. As a result, the user can avoid a situation in which the WL is unintentionally changed through a false operation or an accidental event at WW adjustment.

In the present embodiment, a difference image is exemplarily described as an image, the reference value of which is allocated to a particular pixel value. However, such an image is not limited to a difference image, but may be any other various images, the reference value of each of which is allocated to a particular pixel value in the same manner. For example, the above-described WL change inhibit is also effective at display of a Jacobian map including, as a pixel value, the scaling ratio of each pixel (voxel) when deformation positioning is performed between two kinds of images. The reference value of a Jacobian map is one (no volume change), and thus it is desirable that, when the Jacobian map is displayed, the WL is fixed to a pixel value (typically, one) corresponding to “no volume change” in the map and only the WW is allowed to be operated. The same description applies to display of a displacement field image including, as a pixel value, the movement amount of each pixel (voxel) through deformation when deformation positioning is performed between two kinds of images. Specifically, the reference value of a displacement field image is zero (no displacement), and thus it is desirable that, when the displacement field image is displayed, the WL is fixed to a pixel value (typically, zero) corresponding to “no displacement” in the image and only the WW is allowed to be operated. The status of difference or change can be effectively visualized by displaying an image while the WL is constantly fixed to a part having no difference or change in this manner. As described above, an image, the reference value of which is allocated to a particular pixel value and to which the present invention is applied includes an image generated by converting each difference or change between a plurality of images into a pixel value.

In addition, the above-described WL change inhibit is also effective for any image, the reference value of which is allocated to a particular pixel value other than an image obtained from a difference or change amount between a plurality of images. For example, the WL change inhibit is also effective for an image obtained from the spatial differential of an optional image. In this case, the differential of zero is a reference value. For example, the WL change inhibit may be an image obtained from a result of comparison with a defined value (for example, a normal value or a standard value) of a certain measurement value (concentration or density) at each pixel of an image obtained from a distribution of the measurement values. In this case, the reference value is zero when the comparison is performed based on a difference, or one when the comparison is performed based on a ratio.

In processing actually performed by the mode determining unit 56, for example, a list of display types for which the WL change is inhibited is stored in advance, and header information of an object image to be displayed is compared against this list. The mode determining unit 56 sets the “WL adjustment inhibit mode” when the display type of the object image to be displayed belongs to the list, or sets the “WL adjustment permit mode” otherwise. A reference value of each display type for which the WL change is inhibited may be held in the list, and the WL may be set to a reference value in accordance with the display type of the object image to be displayed. The reference value does not necessarily need to be defined. In a case of a display type, the reference value of which is not defined, a WL held in the header of the image or the current WL may be used as the reference value.

The description of the present embodiment assumes the use of a method of including header information for, for example, each display type in an image file like DICOM. That is, is it mentioned here that the display type of a medical image is determined based on a collateral information such as the header information, and changeover operation of the mode is executed based on the determination result. However, various kinds of header information may be stored in another file independent from an image file, and the header information and the like may be referred to when the body of the image file is read. Specifically, in the present embodiment, a difference image read as an object image to be displayed may be a typical JPEG image. In addition, the collateral information designating the display type is not limited by a style of the header information, but is collated by a conventional connecting style.

The description of the present embodiment assumes that object images to be displayed are three-dimensional images such as MRI and CT images. However, images to be displayed in the present invention are not limited to these images, but may be images in different dimensions such as a two-dimensional simple X-ray image and a 4D CT image including temporally sequential information. The description of the present embodiment assumes that the display control unit 57 uses the window function of the display unit 36 for gray scale images, but a window function for color images may be used.

The present embodiment exemplarily describes a difference image including a difference value between images as a pixel value, but an image expressing the difference between images in any other value may be displayed. For example, an object image to be displayed may be a difference image including the absolute value of the difference as a pixel value. In this case, the object image to be displayed has a reference value of zero (pixel with no change), but the object image to be displayed does not include a negative value, and thus zero is desirably set to be not at the WL (the center of a window) but the lowest end of the window. Then, it is desirable that the WW is allowed to be adjusted whereas the lowest end of the window is fixed. As described above, control of display parameters of an image generated by allocating the reference value thereof to a particular pixel value is not limited to fixation of the WL to the central position of the window.

In the present embodiment, the WL adjustment inhibit mode is a mode in which, when performed, WL adjustment is inhibited in display processing in an “operation related to window adjustment”. In this mode, for example, when the UI illustrated in Section (a) of FIG. 3 is used, the currently set value of the WL is not changed when the change amount of the WL is specified. However, for example, in the mode, the width of a dead zone in a WL change instruction (input value) may be increased from the width of the dead zone in a normal mode so that the WL change instruction in the dead zone is taken to be zero. Alternatively, the instruction may be reduced through, for example, exponential transform to receive the reduced instruction value. In other words, WL adjustment in the mode may be limited. Furthermore, an acceptable range capable of changing the WL may be defined based on the reference value, and the change of the WL may be permitted within the acceptable range even if in the WL adjustment inhibit mode. For example, a rage within from “−a” to “+a” by setting “0” as a center value may be previously set as the acceptable range of the WL. The value of “a” ma be set as 1, 2, or the like. In a case of the WL adjustment inhibit mode, the display parameter setting unit 54 sets the value of the WL in response to the WL change instruction so as to set the value of the WL constantly within the acceptable range. That is, if the value of the WL changed in response to the WL change instruction exceeds the upper limit value of the acceptable range, the value of the WL is set to the upper limit value. If the value of the WL changed in response to the WL change instruction falls below the lower limit value, the value of the WL is set to the lower limit value.

As for the display processing at the image displaying apparatus 10 described above in the first embodiment, at least some of components included in the control unit 50 may be achieved as an independent apparatus or software that achieves the function of each component. At least some of functions achieved by the control unit 50 may be achieved by cloud computing. Specifically, a calculation apparatus placed separately from the image displaying apparatus 10 may be connected through the communication unit 21 to execute the above-described processing through data communication.

As described above, the image displaying apparatus according to an aspect of the present invention includes the image acquiring unit (image acquiring unit) 52, the display type determining unit (determining unit) 55, the display parameter setting unit (setting unit) 54, and the display control unit (display control unit) 57. The image acquiring unit 52 acquires an object image to be displayed from the database 22 or the like. The display type determining unit 55 determines whether the acquired object image to be displayed is a predetermined display type such as a difference image. The display parameter setting unit 54 sets the WL and the WW for displaying the object image to be displayed. When the display type determining unit 55 determines that the display type of the object image to be displayed is the predetermined display type, the display parameter setting unit 54 fixes the WL to a predetermined value such as zero. The display control unit 57 controls the display unit (display unit) 36 to display the object image to be displayed with the WL fixed to the predetermined value or the set WL and with the set WW. A control method of controlling the image displaying apparatus includes a process in which each above-described unit executes processing thereof.

Further, as described above, the image displaying apparatus of another aspect of the present invention includes the image control unit 57 causing the display unit 36 to display the medical image, in accordance with the WL and the WW. The image displaying apparatus also includes, as a display mode a first mode (“WL adjustment inhibit (invalidate) mode” for the image such as the difference image, and a second mode (“WL adjustment permit (validate) mode” for the usual image and the like. In the first mode, an adjustment of the WL is inhibited but an adjustment of the WW is permitted. On the contrary, in the second mode, both the adjustment of the “WL” and the “WW” are permitted. At least one of the display type determination unit 55 and the display parameter setting unit 54 acting as a changeover unit in the image displaying apparatus, changes over the display mode between the first mode and the second mode in the display of the medical image, in accordance with the type of the medical image. Specifically, if the medical image is the difference image as described above, the changeover unit changes the display mode to the first mode. If the medical image is an image of an original and the like of the difference image, of which the WL is not required to be fixed to the predetermined value, the changeover unit changes the display mode to the second mode.

In addition, if the medical image to be displayed is limited to the difference image, the image displaying apparatus of other aspect of the present invention may include the image acquiring unit 52 and the display control unit 57. In such arrangement, the image acquiring unit acquires the difference image designating the difference between a first image and a second image which is obtained by acquiring the same image at a time different from that of the first image. The display control unit 57 causes the display unit 36 to display thus acquired difference image. At that time, the display control unit 57 inhibit the adjustment of a display value corresponding the “0” of the difference value. As the result, the user can easily adjust the WW to observe an appropriate image without paying attention to unintended false adjustment of the WL.

In the above-described embodiment, the display parameter setting unit 54 has a mode in which the WL and the WW can be both set through a single operation such as the mouse drag operation exemplarily illustrated in Section (a) of FIG. 3. In a case of the mouse drag operation and the like, the adjustment of the WL and the WW is executed by the user operation of the mouse drag, and at least one of the WL and the WW is adjusted in accordance with an operation direction of the mouse drag. In such a mode, when the display type determining unit 55 determines that an object image to be displayed is, for example, a difference image, the display parameter setting unit 54 fixes the WL to a predetermined value such as zero. The WL is desirably fixed to a predetermined value also in a setting mode (GUI or setting method) in which the user potentially unintentionally resets the WL. Such a mode includes, for example, a mode in which the WL and the WW can be set through operations similar to each other, in addition to the mode in which the WL and the WW can be both set through a single operation.

In the mode in which the WL and the WW can be set through a single operation, the display parameter setting unit 54 may provide a dead zone of a predetermined range to an input value for setting the WL as described above. That is, in the WL adjustment inhibiting mode as described above, the display control unit 57 actually inhibits the adjustment of the WL by providing the dead zone of the predetermined range for the WL adjusting command from the user. In this case, when a value in the predetermined range is input, the WL is still fixed to a predetermined value. Specifically, in the UI illustrated in Section (a) of FIG. 3, when a mouse cursor used for inputting moves to some extent in the longitudinal direction, an input value corresponding to the movement is not applied. Alternatively, the input value is reduced by, for example, subtracting or scaling down the amount of the movement, and then applied to WL setting. The display parameter setting unit 54 receives WW change while the WL is fixed. In a case that mode changeover command is instructed through the UI, the display control unit may inhibit to adjust the WL by invalidating the UI receiving the WL adjusting command. Alternatively, the WL adjustment may be actually inhibited by hiding the UI itself for instructing the WL adjustment.

The predetermined display type for which the WL is to be fixed in the present invention includes a display type generated by converting each difference or change amount between images into a pixel value. A specific example of the predetermined display type is a difference image generated by converting each difference between a plurality of images of an object into a pixel value, as exemplarily illustrated in the present embodiment. The predetermined display type includes a Jacobian map generated from the scaling ratio of deformation of an object, and a displacement field image generated from the movement amount of each pixel through deformation of the object. In addition, the predetermined display type includes an optional display type, the reference value of which is allocated to a particular pixel value. The display type determining unit 55 determines whether an object image to be displayed is any of these predetermined display types based on information added to the object image to be displayed, which is exemplarily illustrated as a header.

The image displaying apparatus may include the image acquiring unit 52, the display control unit 57, and the display parameter setting unit 54. In this case, the image acquiring unit 52 acquires an object image to be displayed, and the display control unit 57 controls the display unit 36 to display the object image to be displayed with a predetermined WL and a predetermined WW. The display parameter setting unit 54 has a mode in which the predetermined WL and the predetermined WW are both reset through a single operation, and can individually reset the predetermined WL and the predetermined WW. The display parameter setting unit 54 limits setting of the WL in the above-described mode as a control unit when the object image to be displayed is a display type such as a difference image, the reference value of which is allocated to a particular pixel value.

In this case, the control unit may limit the setting by providing the above-described dead zone of a predetermined range to an input value for setting the WL. Alternatively, the control unit may reduce the input value for setting the WL and receive the reduced input value.

As described above, the image displaying apparatus according to the present embodiment can fix the WL to a predetermined value to prevent the WL from being wrongly changed by the user at display of an image, the reference value of which is allocated to a particular pixel value. Accordingly, the user can easily adjust the WW to observe an appropriate image without paying attention to unintended false adjustment of the WL.

### First Modification of First Embodiment

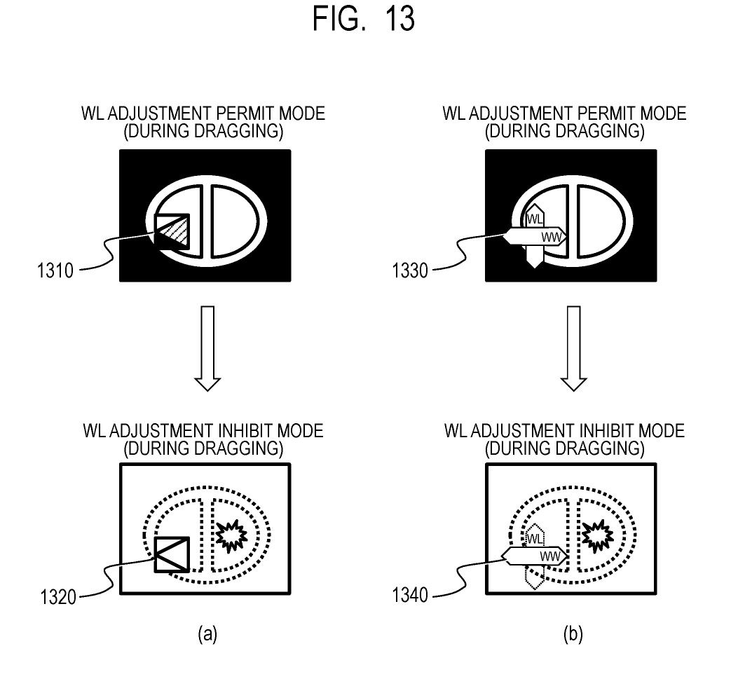

In the processing at step S204 in the first embodiment, when the UI illustrated in Section (a) of FIG. 3 through which the WL and the WW are adjusted through a mouse drag operation is used, the design of the UI may be changed to indicate which of the “WL adjustment permit mode” and the “WL adjustment inhibit mode” is set. For example, the design of a mouse cursor may be changed in accordance with the mode. FIG. 13 illustrates an exemplary WL adjustment and WW adjustment UI displayed on the display unit 36 by the display control unit 57. The following exemplarily describes two designs illustrated in Sections (a) to (b) of FIG. 13.

Sections (a) and (b) of FIG. 13 illustrates an exemplary mouse cursor displayed on an image displayed on the display unit 36 during an “operation related to window adjustment” (during a mouse drag operation) when the UI illustrated in Section (a) of FIG. 3 is used. A mouse cursor illustrated in Section (a) of FIG. 13 notifies, through color combination, the user that an up-down drag operation and a left-right drag operation are associated with WL adjustment and WW adjustment, respectively. Specifically, in the “WL adjustment permit mode” illustrated in an upper part, a mouse cursor 1310 indicates, through vertical color combination of white and black, that WL adjustment is possible by an up-down drag operation. In addition, a gray region expanding toward the right side indicates that WW adjustment is possible by a left-right drag operation. In the “WL adjustment inhibit mode” illustrated in a lower part, a mouse cursor 1320 indicates, through vertical color combination of identical colors, that the WL is not changed by an up-down drag operation.

A mouse cursor illustrated in Section (b) of FIG. 13 notifies, through an arrow and a text, the user that an up-down drag operation and a left-right drag operation are associated with WL adjustment and WW adjustment, respectively. Specifically, in the “WL adjustment permit mode” illustrated in an upper part, a mouse cursor 1330 indicates that WL adjustment and WW adjustment are both possible by displaying both arrows in the up-down and left-right directions without grayout. In the “WL adjustment inhibit mode” illustrated in a lower part, a mouse cursor 1340 indicates, through a grayed out arrow in the up/downward direction indicating WL adjustment, that the WL is not changed by an up-down drag operation.

At step S205, the display control unit 57 sets the display unit 36 to switch a mouse cursor to an above-described GUI during a drag operation. The display unit 36 performs switching between a normal mouse cursor and an above-described mouse cursor in accordance with a drag starting or ending operation by the user. After the user performs a drag operation, the processing steps S206 to S208 are performed to control success or failure of WL adjustment like in, for example, the case illustrated in Section (a) of FIG. 3.

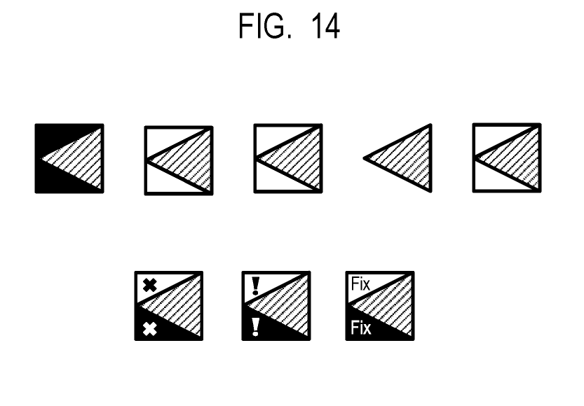

The design of a mouse cursor is not limited to those illustrated in FIG. 13. For example, the mouse cursor 1320 indicating the “WL adjustment inhibit mode” may have various designs as illustrated in FIG. 14.

As described above, the image displaying apparatus according to the present embodiment causes the display unit 36 to display information for easily recognized by the user whether the display mode is changed over to the “WL adjustment permit mode” or “WL adjustment inhibit mode”. The user is allowed to easily tell, from a mouse cursor being dragged, which of the “WL adjustment permit mode” and the “WL adjustment inhibit mode” is set. The display mode is preferably the examples as described above or as Drawings, but any kinds of mode from which the user can easily recognize what mode is used may be used.

### Second Embodiment

In the first embodiment, the type of an image can be determined based on, for example, a header added to the image. However, an image displaying apparatus according to a second embodiment can automatically identify whether an object image to be displayed is, for example, a difference image when there is no description of a header indicating a difference image, and can fix the WL as necessary.

The image displaying apparatus according to the present embodiment has an apparatus configuration same as that of the image display system illustrated in FIG. 1, and thus description of the apparatus configuration will be omitted below. The procedure of processing according to the present embodiment is same as the procedure of the image display processing in the first embodiment, which is illustrated as a flowchart in FIG. 2. However, processing performed by the display type determining unit 55 at step S202 is different from that in the first embodiment. The following only describes step S202 in the present embodiment, and omits description of the other steps.

At step S202, the display type determining unit 55 determines the display type of the object image to be displayed that is read at step S201. First, the display type determining unit 55 determines whether information indicating a display type is included in the header of the object image to be displayed. Then, when the information is included, similarly to the first embodiment, the display type determining unit 55 reads the information in the header and determines a display type based on the information. When the information is not included, the display type determining unit 55 determines a display type based on information of pixel values in the image. The display type determining unit 55 may determine a display type constantly based on information of pixel values in the image irrespective of the availability of the header information.

In the present embodiment, the display type determining unit 55 generates, for example, the histogram of pixel values of the image as information of pixel values, and determines a display type based on characteristics of the histogram. That is, in the embodiment, the display type of the medical image is determined based on distribution of pixel values of the medical image, and the changeover operation is executed based on the determination result. The determination of a display type is mainly performed to obtain information used to determine the setting mode of display parameters at step S204. Thus, it is most important to determine whether an object image to be displayed is an image, the reference value of which is allocated to a particular pixel value.

Whether the object image to be displayed is a difference image may be determined based on, for example, whether the image satisfies any of the following conditions. Specifically, determination is performed between the following conditions, and the determination is performed based on a result of the determination.

Condition 1: Pixel values have a maximum peak of zero (or near zero), and have a highly symmetric distribution (the matching degree thereof is equal to or higher than a threshold) centered at a pixel value at the maximum peak.

Condition 2: High matching degree (equal to or higher than a threshold) with the histogram of an average difference image.

Condition 3: Identification as a difference image based on an inference model that has learned the histograms of normal and difference images.

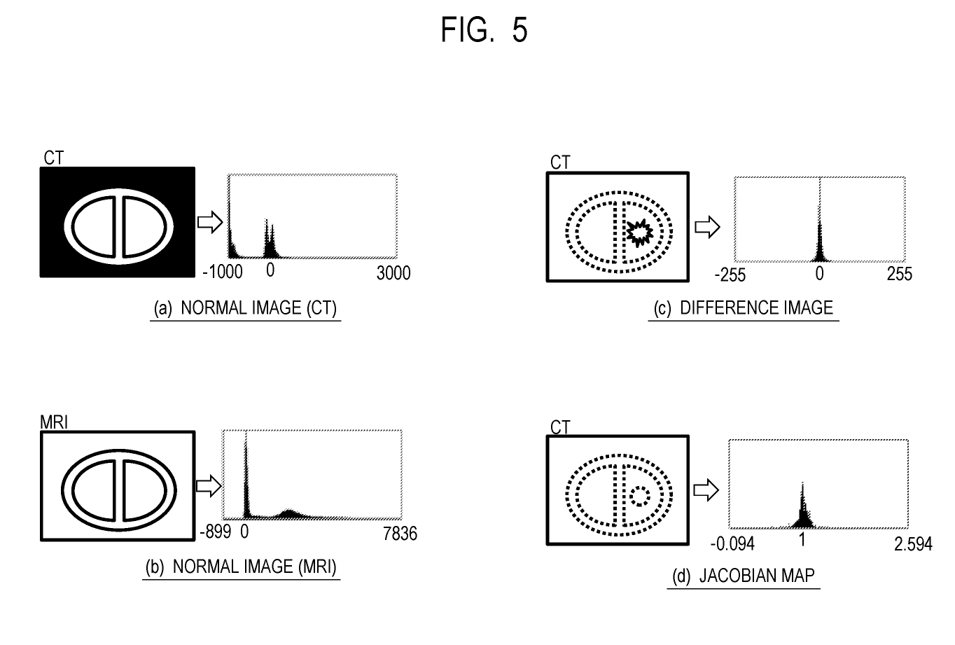

FIG. 5 illustrates a normal CT image (Section (a) of FIG. 5), a normal MRI image (Section (b) of FIG. 5), a difference image (Section (c) of FIG. 5), a Jacobian map (Section (d) of FIG. 5), and exemplary histograms thereof. A CT image and an MRI image each often has a peak pixel value at or near zero, and typically have an asymmetric histogram centered at the peak pixel value. A difference image has a peak pixel value at zero and has a substantially symmetric histogram centered at the peak pixel value. The control unit 50 in the present embodiment determines a difference image from any other image based on these characteristics.

Similarly, when any image other than a difference image is displayed as an image, the reference value of which is allocated to a particular pixel value, too, a display type can be determined based on information of pixel values in the image. For example, as illustrated in Section (d) of FIG. 5, a Jacobian map has a substantially symmetric histogram centered at a peak at one. The histogram of a displacement field image has a distribution similar to that of a difference image. Thus, it is difficult to distinguish a difference image and a displacement field image based on the histograms thereof in some cases. However, transition to a mode in which the WL is fixed to zero is achieved when the object image to be displayed is determined to be an image, the reference value of which is allocated to zero, and thus the difficulty is not a problem. Specifically, it only needs to determine whether the object image to be displayed is an “image, the reference value of which is allocated to the pixel value of zero”, an “image, the reference value of which is allocated to the pixel value of one”, or an “image, the reference value of which is not allocated to a particular pixel value” (any of the display types thereof). In this case, at step S203, the display parameter setting unit 54 sets the initial value of the WL to be zero when the display type of the object image to be displayed is an “image, the reference value of which is allocated to the pixel value of zero”. The display parameter setting unit 54 sets the initial value of the WL to be one when the display type of the object image to be displayed is an “image, the reference value of which is allocated to the pixel value of one”. Further, at step S204, the mode determining unit 56 determines the setting mode of display parameters to be the “WL adjustment inhibit mode” when the display type of the object image to be displayed is an “image, the reference value of which is allocated to the pixel value of zero” or an “image, the reference value of which is allocated to the pixel value of one”. Otherwise, the display parameter setting unit 54 determines the setting mode of display parameters to be the “WL adjustment permit mode”.

### First Modification of Second Embodiment

In the second embodiment described above, the histogram of an object image to be displayed is generated and used to determine a display type. However, the display type determination may be performed by directly analyzing an image without using a histogram. In the present modification, for example, when satisfying any of conditions as described below, the object image to be displayed is determined to be a difference image. In other words, determination is performed between the following conditions, and the determination is performed based on a result of the determination.

Condition 1: High matching degree with statistics information of an average difference image.

Condition 2: Identification as a difference image based on a model that has learned the tendency of difference images by machine learning.

In such a case, the object image to be displayed is determined to be a difference image, and the processing at step S203 and later in the flowchart illustrated in FIG. 2 is executed.

### Second Modification of Second Embodiment

As described above, in the second embodiment and the modification thereof, the display type of an object image to be displayed is determined by analyzing the object image to be displayed based on the histogram or the like thereof, and the processing at step S203 and later is executed after a result of the determination is obtained. However, the present embodiment is not limited to such an aspect. For example, the display type determine processing at step S202 may be omitted.

Specifically, the image analysis performed in, for example, the second embodiment described above may be executed at step S204. More specifically, without performing the display type determination, the mode determining unit 56 may directly determine whether to set the “WL adjustment inhibit mode” or the “WL adjustment permit mode” based on a result of analyzing the histogram of the object image to be displayed. For example, the “WL adjustment inhibit mode” may be set when the histogram is determined to have a highly symmetric distribution centered at a peak (has a symmetric property exceeding a predetermined reference), or the “WL adjustment permit mode” may be set otherwise. Alternatively, machine learning may be performed in advance on the histograms of images for which the “WL adjustment inhibit mode” is desired to be set and images for which the “WL adjustment permit mode” is desired to be set, thereby automatically determining which mode is to be set for the object image to be displayed.

When the “WL adjustment inhibit mode” is set based on a result of the above-described determination, the value of the WL may be set relative to the peak position of the histogram. In this manner, for example, the peak position can be directly set as the value of the WL. Alternatively, the WL may be set to be zero when the peak position is within a predetermined distance from zero, or the WL may be set to be one when the peak position is within a predetermined distance from one. In this case, each predetermined distance corresponds to an optional range of pixel values, such as a range corresponding to pixel values of two to three pixels from a pixel value at the peak position. Alternatively, the WL held in the header of the image may be used as the reference value. With this configuration, when the display type is unknown, the display type can be estimated, and the WL can be appropriately controlled in accordance with the display type.

As described above, in the present embodiment, the display type determining unit 55 determines whether an object image to be displayed is a predetermined display type such as a difference image based on a distribution of pixel values of the object image to be displayed. The WL is fixed to a predetermined value when the object image to be displayed is determined to be the predetermined display type and the WW is changed in a setting mode in which the user potentially unintentionally resets the WL while the WL is not to be changed.

As described above, at display of an image, the reference value of which is allocated to a particular pixel value, the image displaying apparatus according to the present embodiment can fix the WL to a predetermined value when no header information that specifies the display type of the image is available. In addition, the user can be prevented from being wrongly changing the WL, and thus can easily adjust the WW to observe an appropriate image without paying attention to unintended false adjustment of the WL.

### Third Embodiment

As described above, the image displaying apparatus according to the present invention reads an object image to be displayed from the database 22 and the storage unit 34, or acquires an object image to be displayed directly from an image capturing apparatus. In this case, images to be read include images captured by various apparatuses and images generated therefrom, and thus some images do not include appropriate header information nor the display types thereof cannot be automatically determined. An image displaying apparatus according to a third embodiment fixes the WL based on explicit or implicit display type specification by the user.

The image displaying apparatus according to the present embodiment has an apparatus configuration same as that of the image display system illustrated in FIG. 1, and thus description of the apparatus configuration will be omitted below. The procedure of processing according to the present embodiment is same as the procedure of the image display processing in the first embodiment, which is illustrated as a flowchart in FIG. 2. However, the processing performed by the display type determining unit 55 at step S202 in the first embodiment is different in the present embodiment. The following only describes processing at step S202 in the present embodiment and any related processing, and omits description of the other steps.

In the present embodiment, at step S202, the operation content analyzing unit 53 acquires an operation of specifying a display type input to the control unit 50 through the operation unit 35 or an operation of selecting preset values of the WL and the WW. Then, processing related to an acquired operation is performed. In the present embodiment, the user directly executes the input operation at step S202 based on an image specified and read from the database 22 or the like by the image displaying apparatus 10. Alternatively, an image read at step S201 may be temporarily displayed on the display unit 36, and then the user may perform the input operation by referring to the image at step S206. In this case, display conditions of the WL, the WW, and the like are predetermined values, but may be values specified by the user in advance. The user, for example, refers to the display image, and performs any of an operation of specifying a display type through the operation unit 35 and an operation of selecting the preset values of the WL and the WW.

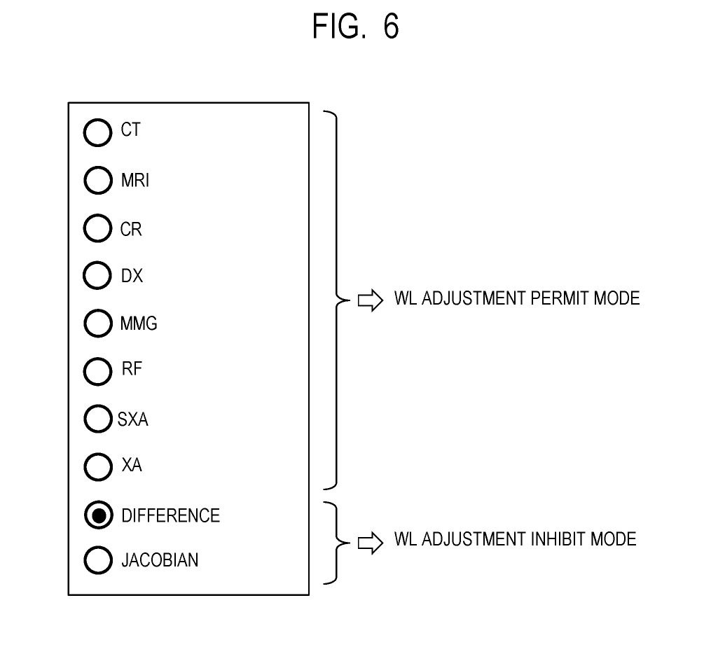

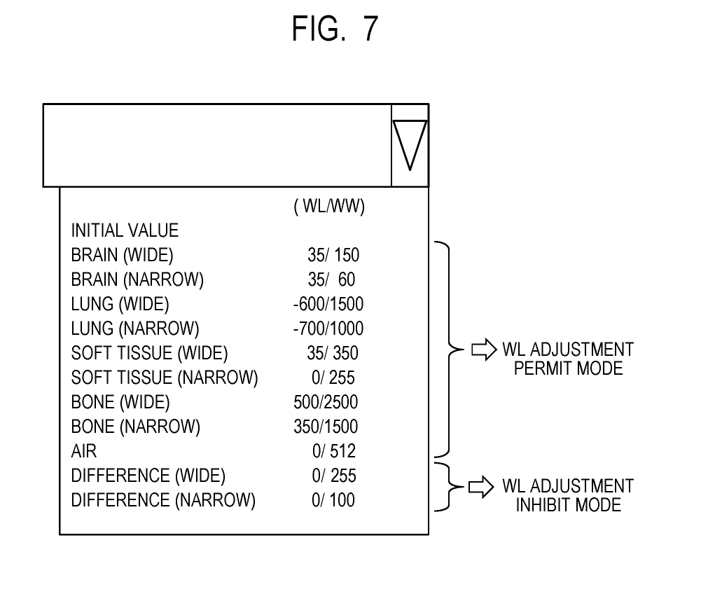

FIGS. 6 and 7 illustrate exemplary GUIs displayed on the display unit 36 by the display control unit 57 and operated by the user through the operation unit 35. FIG. 6 illustrates an exemplary display type specification GUI which uses a radio button. Through this GUI, the user can explicitly specify a display type by selecting (e.g., a click of the mouse) selectable items (e.g., radio button) associated with the display type to be designated. FIG. 7 illustrates an exemplary GUI using a pull-down menu, through which preset values are set to condition (WL/WW). Through this GUI, the user can select appropriate display parameters in accordance with an observation site and a display type by selecting (e.g., a click of the mouse) selectable items (e.g., pull-down items) associated with the display type to be designated. A display type is implicitly specified simultaneously with selection of display parameters by using the GUI illustrated in FIG. 7, and thus the operation content analyzing unit 53 can acquire information used to estimate the display type.

Specifically, the user selects desired display parameters (hereinafter referred to as preset values) from a WL and WW preset list illustrated in FIG. 7, and the operation content analyzing unit 53 determines whether the selected preset values are, for example, preset values for a difference image. For example, when preset values including a preset value indicating the WL=0 are selected, the preset values are determined to be preset values for a difference image. However, the WL of a normal image is specified to be zero in some cases. Thus, another determining method is desirably applied as described below to perform, for example, display type specification in parallel.

In the preset list exemplarily illustrated in FIG. 7, each preset name is defined in a pair with WL and WW preset values. The operation content analyzing unit 53 may determine whether the preset values are for a difference image based on the preset name. For example, when a preset name includes the string of “difference”, selected preset values are determined to be for a difference image. Alternatively, each preset value may have a flag indicating whether the preset value is for a difference image, and a preset value selected when the flag is true may be determined to be for a difference image.

At step S203, the operation content analyzing unit 53 acquires a display type and display parameters based on the content of an operation. The control unit 50 executes the processing at step S203 and later by using a display type specified by the user. As a result, in the processing at step S204, an appropriate setting mode of display parameters (the “WL adjustment permit mode” or the “WL adjustment inhibit mode”) is set in accordance with the display type specified by the user.

In this manner, a display type and display parameters, which are read from a header in the first embodiment, are acquired in accordance with a user operation in the present embodiment. Thus, the display parameters initially set at step S203 and the setting mode of display parameters determined at step S204 are set and determined in accordance with these acquired display type and preset values. At step S205, the display control unit 57 controls the display unit 36 to display an image generated by using the display parameters. When the above-described operation of specifying a display type is acquired at step 206, the operation content analyzing unit 53 calls processing in accordance with the content of the operation at step 207. Accordingly, in addition to the bifurcation in the first embodiment, the processing proceeds to step S203 when the operation of specifying a display type is received. Then, the above-described processing at step S203 and later is executed. The UI operated by the user may be any other UI that allows specification or estimation of a display type.

The UI may include an UI through which the user instructs switching between the “WL adjustment inhibit mode” and the “WL adjustment permit mode” without the display type specification. For example, the UI through which the user directly instructs the mode switching may be configured to set the “WL adjustment inhibit mode” while a predetermined key (for example, a “Shift key” or a “Ctrl key”) is pressed down or set the “WL adjustment permit mode” otherwise. Alternatively, in the above-described configuration in which a mode is set based on a display type and the like, for example, the modes may be inverted while a predetermined key is pressed down. Specifically, the “WL adjustment permit mode” may be set while a predetermined key is pressed down when the “WL adjustment inhibit mode” is set based on a display type and the like. Similarly, the “WL adjustment inhibit mode” may be set while a predetermined key is pressed down when the “WL adjustment permit mode” is set based on a display type and the like.

When an UI through which the WL and the WW are adjusted through a mouse drag operation is used as another example UI through which the user directly instructs the mode switching, a mode may be determined based on a direction in which a mouse is first moved in a drag operation and switching to the mode may be performed. Specifically, the “WL adjustment inhibit mode” may be set when the mouse is first moved in the lateral direction after start of the drag operation, or the “WL adjustment permit mode” may be set otherwise (when the mouse is first moved in the longitudinal direction or an oblique direction). When the mouse is first moved in the longitudinal direction, a “WW adjustment inhibit mode” in which only WL adjustment is permitted may be set. A mode may be determined based on the movement direction of the mouse once the movement amount of the mouse exceeds a predetermined threshold because an operation in the longitudinal and lateral directions right after a drag operation often cannot be accurately determined in a manual operation. The above-described switching processing may be performed only when the display type of an object image to be displayed is an “image, the reference value of which is not allocated to a particular pixel value”. In this case, when the display type of the object image to be displayed is a typical image, not an “image, the reference value of which is not allocated to a particular pixel value”, the “WL adjustment permit mode” may be set irrespective of a “direction in which the mouse is first moved” without performing the above-described switching processing.

As described above, in the present embodiment, the display type determining unit 55 determines whether an object image to be displayed is a predetermined display type such as a difference image based on a display type specified by the user. The WL is fixed to a predetermined value when the object image to be displayed is determined to be a predetermined display type and the WW is changed in a setting mode in which the user potentially unintentionally resets the WL while the WL is not to be changed. That is, as described above, the image displaying apparatus of another aspect of the present invention includes the image control unit 57 causing the display unit 36 to display the medical image, in accordance with the WL and the WW. The image displaying apparatus also includes as a display mode a first mode (“WL adjustment inhibit (invalidate) mode” for the image such as the difference image, and a second mode (“WL adjustment permit (validate) mode” for the usual image and the like. In the first mode, an adjustment of the WL is inhibited but an adjustment of the WW is permitted. On the contrary, in the second mode, both the adjustment of the “WL” and the “WW” are permitted. At least one of the display type determination unit 55 and the display parameter setting unit 54 acting as a changeover unit, changes over the display mode between the first mode and the second mode in the display of the medical image, in accordance with the specific kinds of an operation of the user. Specifically, if an operation designating that the medical image is the difference image as described above is executed, the changeover unit changes the display mode to the first mode. If an operation designating that the medical image is an image of an original and the like for the difference image, of which the WL is not required to be fixed to the predetermined value is executed, the changeover unit changes the display mode to the second mode.

For Example, in a case that an input relating to the display mode is executed by the operation unit 35, e.g., keyboard, if the predetermined key of the keyboard is depressed as the user operation, it is determined that the mode change over command is instructed. In the above described embodiment, the display mode is changed over to the first mode in accordance with such operation. Alternatively, in a case that an input relating to the display mode is executed by the mouse drag and the like, the user operation for adjusting the WL and the WW is the mouse drag operation. The display mode is changed over in accordance with a drag direction at a time of starting the mouse drag operation. In the above described embodiment, the display mode is changed over to the first mode in accordance with such operation.

Alternatively, the image displaying apparatus of the present invention may include a display control unit 57 and a change unit having units such as the operation content analyzing unit 53 and the display parameter setting unit 54. In such case, the change unit sets the WL as a fixed value and adjusts the WW in accordance with an operation of the user instructing the adjustment of the WL and the WW of the medical image. In the above described embodiment, only an aspect that the WL is fixed is described. However, the present invention includes an aspect wherein an adjusted amount of the WL is set smaller than that of the WW to obtain the effect which is obtained by fixing the WL. For example, in the operation of the above described change unit, an changing ratio of the WL in response to the WL adjusting amount is set smaller than that of the WW in response to the WW adjusting amount. As the result, the reference value is adjusted but the user can broadly know the overall trend of the adjusted result.

As described above, at display of an image, the reference value of which is allocated to a particular pixel value, the image processing apparatus according to the present embodiment can fix the WL to a predetermined value in accordance with explicit or implicit display type specification by the user. The user can be prevented from wrongly changing the WL, and thus can easily adjust the WW to observe an appropriate image without paying attention to unintended false adjustment of the WL.

### Fourth Embodiment

In addition to the configurations described in the above-described first to three embodiments, an image displaying apparatus according to a fourth embodiment converts pixel values into display values so that the user can visually recognize difference information in a simplified and intuitive manner. Specifically, in the present embodiment, the display control unit 57 non-linearly converts pixel values of an object image to be displayed into display values and displays the image.

The image displaying apparatus according to the present embodiment has an apparatus configuration same as that of the image display system illustrated in FIG. 1, and thus description of the apparatus configuration will be omitted below. The procedure of processing according to the present embodiment is same as the procedure of the image display processing in the first embodiment, which is illustrated as a flowchart in FIG. 2. However, the present embodiment is different from the above-described first embodiment and the like that the formula of conversion from pixel values to display values at step S205 is switched in accordance with a display type. The following only describes the processing performed at step S205 in the present embodiment, and omits description of the other steps.

In the present embodiment, at step S205, the display control unit 57 changes the processing content of conversion from pixel values to display values at image display in accordance with the display type of an object image to be displayed acquired at step S202. For example, when the display type is a difference image, the method of conversion from pixel values to display values is set to be Sigmoid, and then the conversion from pixel values to display values is performed. When the display type is any other image, the conversion formula is set to be Linear, which is employed by a normal window function, and then the conversion from pixel values to display values is performed. When the display type is determined to be a Jacobian map at step S202, the conversion formula is set to be Log, and then the conversion from pixel values to display values is performed. A display image subjected to the conversion to display values is displayed on the display unit 36 by the display control unit 57.

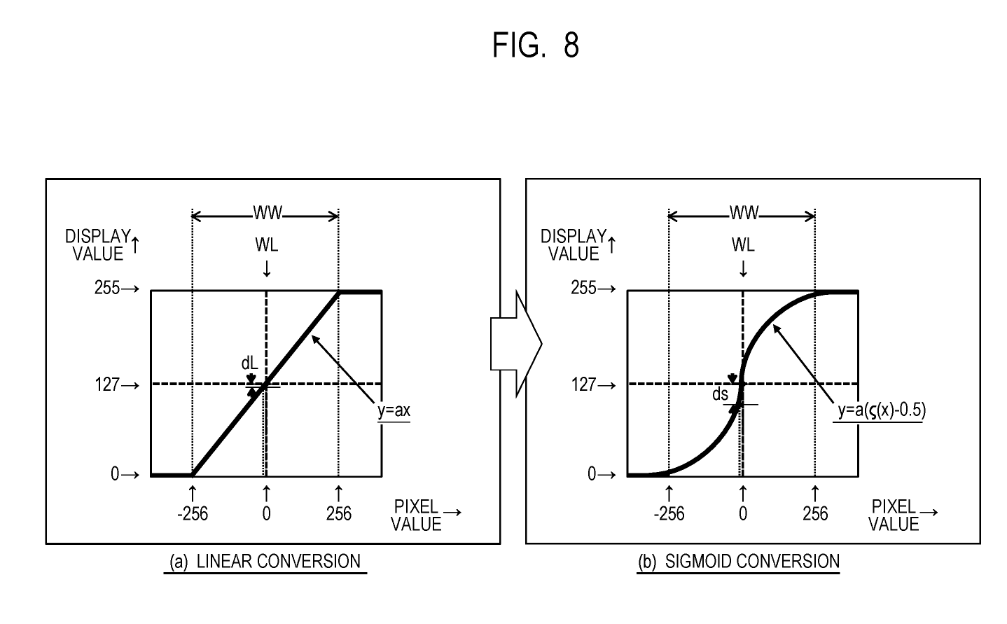

FIG. 8 is a diagram for description of any difference in conversion from pixel values to display values when the conversion formula for a difference image is changed from Linear to Sigmoid. In Section (a) of FIG. 8 illustrating conventional Linear conversion, the display value is close to the central value for a small difference, which makes it difficult for the user to recognize the existence of the difference from the difference image. When the conversion formula is changed to Sigmoid conversion illustrated in Section (b) of FIG. 8, the display value is largely separated from the central value for a small difference. For example, when the display value differs from the display value of 127 by a difference dl near the pixel value of zero at the central value in Section (a) of FIG. 8, the difference is increased to a difference ds illustrated in Section (b) of FIG. 8 by applying the Sigmoid conversion. This allows the user to easily identify the existence of the difference from the difference image.

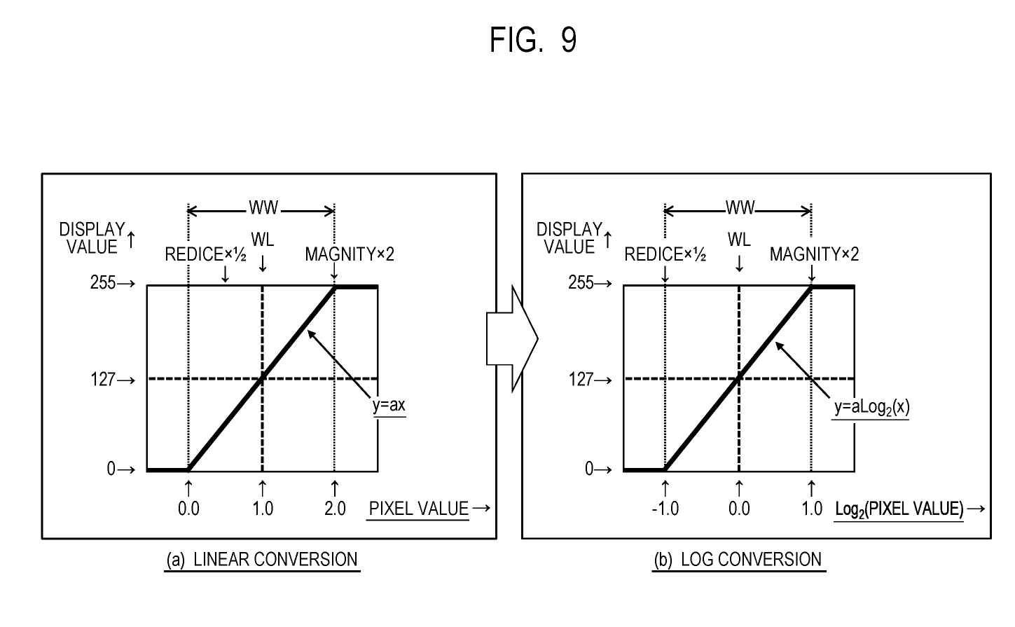

FIG. 9 is a diagram for description of any difference in conversion from pixel values to display values when the conversion formula for a Jacobian map is changed from Linear to Log. In Section (a) of FIG. 9 illustrating conventional Linear conversion, the pixel value of a pixel scaled two times larger and the pixel value of a pixel scaled ½ times larger are asymmetric to each other with respect to the central value of 1.0. Thus, when the conversion to display values is performed, the scaling down side does not become sufficiently dark for substantially equal scaling ratios, and thus it is difficult for the user to intuitively recognize the degree of deformation from the Jacobian map. When the conversion formula is changed to Log conversion illustrated in Section (b) of FIG. 9, values are symmetric with respect to the central value of 0.0 for substantially equal scaling ratios, and thus the user can easily recognize the degree of scaling-up or -down based on the brightness or darkness of the Jacobian map.

The above description of the embodiment assumes a particular combination of a display type and a conversion formula, but display types and conversion formulae are not limited to those exemplarily described in the embodiment. Any other display types and conversion formulae may be employed. In the above-described embodiment, one conversion formula is allocated for each kind of difference, but a plurality of conversion formulae may be allocated to an identical kind of difference image. In addition to automatic allocation of a conversion formula based on the kind of difference, conversion formulae may be switched by user specification.

As described above, at display of an image, the reference value of which is allocated to a particular pixel value, the image displaying apparatus according to the present embodiment can display, in an enhanced manner, a small difference or substantially equal change amounts such as scaling-up and -down amounts. Thus, when an object image to be displayed illustrates the difference or change amount between a plurality of images, in a simplified or intuitive manner, the object image to be displayed can be converted into an image that allows recognition of the difference or change between images and displayed.

### Fifth Embodiment

Display parameters of a window function may be automatically adjusted in an image displaying apparatus. In an image displaying apparatus according to a fifth embodiment, when display parameters of the window function are automatically adjusted, the WL is maintained at display of an image such as a difference image, the reference value of which is allocated to a particular pixel value. Specifically, in the present embodiment, at display of an image, the reference value of which is allocated to a particular pixel value, the display parameter setting unit 54 automatically adjusts the WW based on a distribution of pixel values of an object image to be displayed while the WL is fixed.

The image displaying apparatus according to the present embodiment has an apparatus configuration same as that of the image display system illustrated in FIG. 1, and thus description of the apparatus configuration will be omitted below. The procedure of processing according to the present embodiment is same as the procedure of the image display processing in the first embodiment, which is illustrated as a flowchart in FIG. 2. However, the present embodiment is different from any other above-described embodiments in that an operation of instructing automatic adjustment of display parameters is acquired at step S206 in the first embodiment and the display parameters are automatically adjusted at step S208. The following describes the processing steps S206 to S208 in the present embodiment, and omits description of the other steps.

In a typical method of automatically adjusting display parameters of a window function, the maximum and minimum values of pixel values of an object image to be displayed (or part thereof) are allocated to the maximum and minimum values of each window. With this method, what are called image overexposure and underexposure can be avoided. In a known automatic adjustment method other than this method, display parameters are set based on distribution information (average value and dispersion) of pixel values of the object image to be displayed. However, when automatic adjustment of display parameters is performed on an image such as a difference image having various distributions of pixel values by the above-described typical methods, the WL cannot be maintained at a predetermined reference value in some cases.

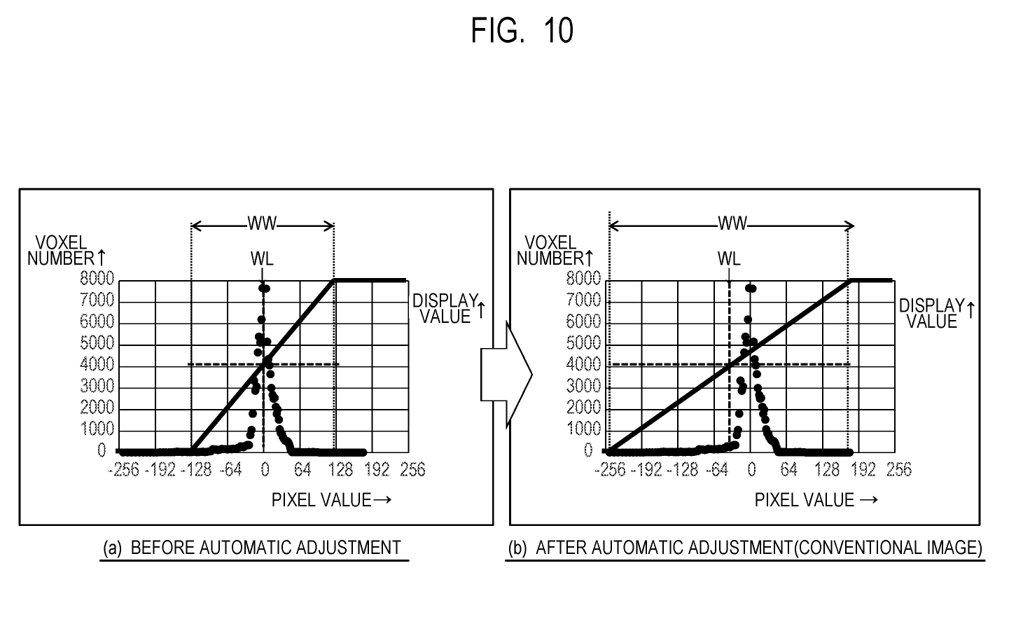

The following describes, with reference to FIG. 10, a case in which automatic adjustment of display parameters is performed on an actual difference image by the above-described typical method of allocating the maximum and minimum values of pixel values of an object image to be displayed to the maximum and minimum values of a window. Section (a) of FIG. 10 illustrates the relation between the histogram of the difference image and display parameters before the automatic adjustment. Section (b) of FIG. 10 illustrates the relation between the histogram of the difference image and display parameters after the automatic adjustment of display parameters by the above-described typical method. As understood from Section (b) of FIG. 10, the WL is basically set to be a central pixel value the maximum and minimum values, and thus the WL after the automatic adjustment is set to be a value different from zero as the reference value.

However, in automatic setting of display parameters in the present embodiment, the WL is fixed to zero and the following WW adjustment is performed. In the present embodiment, at step S206, the operation content analyzing unit 53 receives an operation performed by the user through the operation unit 35. In the present embodiment, at least an operation of instructing the automatic adjustment of display parameters is received in addition to an operation same as that in the first embodiment. The automatic adjustment may be automatically performed irrespective of a user operation. Alternatively, the automatic adjustment may be determined by the display parameter setting unit 54 in accordance with header information such as a display type, or may be specified by the user in accordance with the header information.

At step S207, the operation content analyzing unit 53 calls processing in accordance with the content of the operation. Specifically, in addition to the bifurcation in the first embodiment, the processing proceeds to step S208 when an operation of instructing the automatic adjustment of display parameters is received. At step S208, the display parameter setting unit 54 automatically sets the WL and the WW by a method in accordance with the current setting mode of display parameters. When the “WL adjustment inhibit mode” is set, the display parameter setting unit 54 sets the WL and the WW as display parameters as described below. Specifically, the WL is set to be a reference value (zero for a difference image), and the WW is set to be twice as large as the larger one of “maximum pixel value—WL” and “WL—minimum pixel value”. This sets a minimum window including, in the window range, the pixel values of all pixels of an object image to be displayed while the WL is fixed to the reference value. When the “WL adjustment permit mode” is set, the display parameter setting unit 54 sets display parameters by an automatic adjustment method as conventionally done.

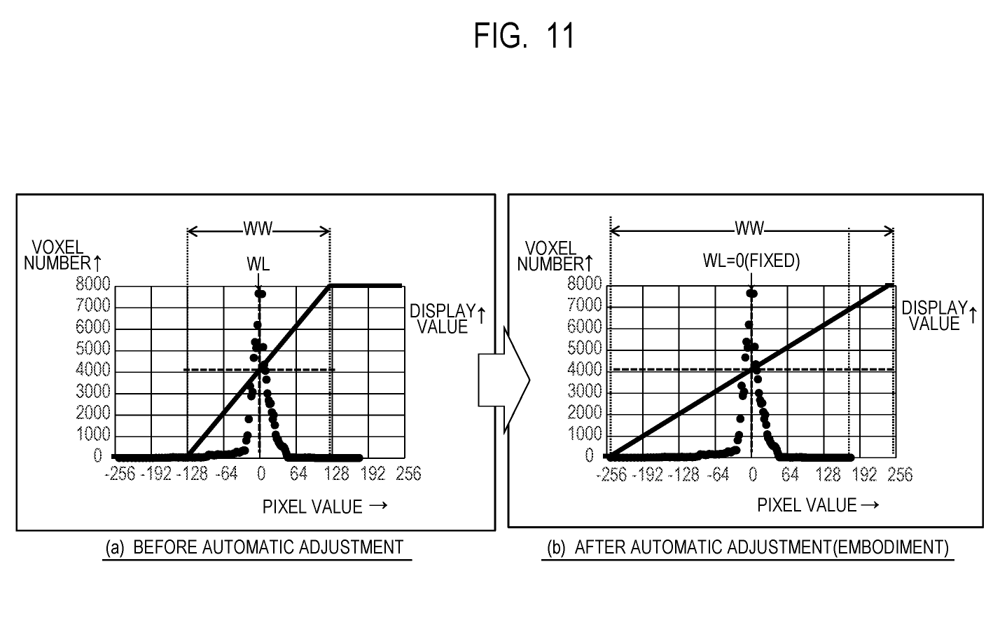

FIG. 11 is a diagram for description of an example in which automatic adjustment of display parameters is performed on an actual difference image in the present embodiment. Section (a) of FIG. 11 illustrates the histogram of pixel values of the difference image and display parameters before the automatic adjustment. Section (b) of FIG. 11 illustrates the histogram of pixel values of the difference image and display parameters after the automatic adjustment. In this example, “WL—minimum pixel value” is larger among “maximum pixel value—WL” and “WL—minimum pixel value”, and thus the WW is set to be twice as large as “WL—minimum pixel value”. The WL is fixed to zero. When the automatic adjustment of display parameters is performed by a method illustrated in Section (b) of FIG. 11, display parameters are set so that the pixel values of all pixels of an object image to be displayed are included in the window range while the WL is maintained at zero, avoiding overexposure and underexposure of the pixel values.

In the above-described processing at step S208, the “minimum value” of “maximum pixel value—WL” and “WL—minimum pixel value” may be used in place of the “maximum value” thereof to calculate the WW in the “WL adjustment inhibit mode”. With this method, some pixels are not included in the window range, and thus overexposure or underexposure cannot be avoided. However, it is prioritized to exploit the gradation expression performance of a display apparatus in such a case.

The above-described processing of setting display parameters by using the maximum and minimum values of pixel values of an object image to be displayed is exemplary processing performed by the display parameter setting unit 54 at step S208, and the automatic setting of display parameters may be performed by any other method. For example, a method of setting display parameters by analyzing the distribution of pixel values of an object image to be displayed may be used. For example, when the “WL adjustment permit mode” is set, the WL may be set to be the average value (or mode) of pixel values, and the WW may be set based on dispersion of the pixel values (for example, the WW is set to be the range of 3[sigma]). When the “WL adjustment inhibit mode” is set, the WL is set to be the reference value of an object image to be displayed. Similarly to the “WL adjustment permit mode”, the WW may be set based on dispersion of pixel values of the object image to be displayed. Alternatively, dispersion when the reference value is set as an average value may be calculated to set the WW based on the calculated dispersion (for example, set the WW to be the range of 3[sigma]). With this configuration, the automatic setting of display parameters can be achieved without being affected by any outliner.

### First Modification of Fifth Embodiment

In the automatic adjustment of display parameters according to the fifth embodiment described above, the WW is set to have equal widths in a range (left side) in which the pixel value is smaller than the WL and a range (right side) in which the pixel value is larger than the WL. However, instead of using a straight line passing through the current WL in this manner, the WW may be individually adjusted on each of sides of the current WL on which the pixel value is larger and smaller, thereby avoiding waste of gradation expression while the WL is fixed to a predetermined value.

In the present modification, unlike the fifth embodiment, luminance adjustment (conversion from pixel values to display values) is performed separately for both sides of the current WL on which the pixel value is larger and smaller in a case of a difference image. Specifically, display parameters are adjusted on the sides of the WL on which the pixel value is larger and smaller based on, for example, a condition as follows. Specifically, on the side smaller than the WL (display value of 127), conventional pixel value adjustment is performed in the range of display values of 0 to 126 based on the WL and the minimum pixel value. On the side larger than the WL, conventional pixel value adjustment is performed in the range of display values of 128 to 255 based on the WL and the maximum pixel value.

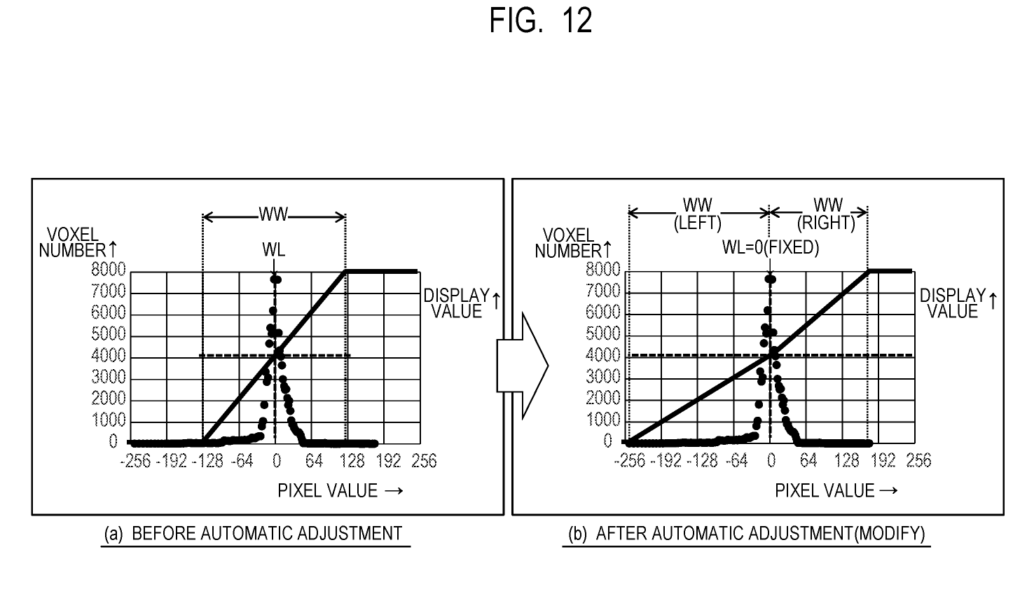

FIG. 12 is a diagram for description of an example in which the automatic adjustment of display parameters is performed on an actual difference image in the present modification. The automatic adjustment of display parameters is performed on a difference image in Section (a) of FIG. 12 illustrating a histogram and pixel values before the automatic adjustment, which is same as that in FIG. 11. As illustrated in Section (b) of FIG. 12, the gradient of a straight line representing a conversion formula changes between sides of the WL on which the pixel value is larger and smaller. According to this method, all pixel values are to be displayed while the WL is maintained at zero, and thus the above-described overexposure and underexposure can be avoided. Moreover, all pixel values correspond to respective display values, which solves the problem of pixel values not included in the window range and avoids waste of gradation expression.

As described above, at display of an image, the reference value of which is allocated to a particular pixel value, the image displaying apparatus according to the present embodiment can perform the automatic adjustment of display parameters while a predetermined WL is maintained for, for example, a difference image.

In the above-described embodiments, the display unit displays an object image to be displayed with a fixed or set window level and a set window width. However, the image displaying apparatus according to the present invention is not limited to this configuration, and may only perform processing of generating a display image through conversion from pixel values of the object image to be displayed by processing equivalent to the above-described window function, and storing the generated display image. In other words, the display control unit described above as an image converting unit configured to convert the object image to be displayed may function to display the object image to be displayed with a fixed or set window level and a set window width.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present invention is described above with reference to the embodiments. However, the present invention is not limited to the above-described embodiments. The present invention includes an invention obtained by modifying the present invention without departing from the scope of the present invention, and an invention equivalent to the present invention. The above-described embodiments and modifications may be combined as appropriate without departing from the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-134689, filed Jul. 10, 2017, and Japanese Patent Application No. 2018-127501, filed Jul. 4, 2018, which are hereby incorporated by reference herein in their entirety.

What is claimed is:

1. An image displaying apparatus comprising:
an image acquiring unit configured to acquire an object image to be displayed;
a determining unit configured to determine whether the object image to be displayed is a predetermined display type, a reference value of which is allocated to a particular pixel value;
a setting unit configured to set a window level and a window width for displaying the object image to be displayed and fix the window level to a predetermined value when the determining unit determines that the object image to be displayed is the predetermined display type; and
an image converting unit configured to convert the object image to be displayed so that the object image to be displayed is displayed with the window level fixed to the predetermined value or the set window level and with the set window width.

2. The image displaying apparatus according to claim 1, further comprising a display control unit configured to cause a display unit to display the converted object image to be displayed.

3. The image displaying apparatus according to claim 1, wherein the setting unit has a mode in which the window level and the window width can be both set through a single operation and fixes the window level to the predetermined value when the object image to be displayed is determined to be of the predetermined display type in the mode.

4. The image displaying apparatus according to claim 3, wherein the setting unit fixes, in the mode, the window level to the predetermined value by providing a dead zone of a predetermined range to an input value for setting the window level.

5. The image displaying apparatus according to claim 1, wherein the setting unit receives change of the window width while the window level is fixed.

6. The image displaying apparatus according to claim 1, wherein the setting unit automatically adjusts the window width based on a distribution of pixel values of the object image to be displayed while the window level is fixed.

7. The image displaying apparatus according to claim 1, wherein the reference value is set as a window level.

8. The image displaying apparatus according to claim 1, wherein the predetermined display type is a display type of an image obtained from a difference or change amount between a plurality of images.

9. The image displaying apparatus according to claim 8, wherein the predetermined display type is a difference image generated by converting each difference between the plurality of images into a pixel value.

10. The image displaying apparatus according to claim 8, wherein the predetermined display type is a Jacobian map generated from a scaling ratio of deformation between the plurality of images.

11. The image displaying apparatus according to claim 8, wherein the predetermined display type is a displacement field image generated from a movement amount of each pixel between the plurality of images.

12. The image displaying apparatus according to claim 1, wherein the determining unit determines whether the object image to be displayed is the predetermined display type based on information added to the object image to be displayed.

13. The image displaying apparatus according to claim 1, wherein the determining unit determines whether the object image to be displayed is the predetermined display type based on a distribution of pixel values of the object image to be displayed.

14. The image displaying apparatus according to claim 1, wherein the determining unit determines whether the object image to be displayed is the predetermined display type based on a display type specified by a user.

15. The image displaying apparatus according to claim 1, wherein the image converting unit non-linearly converts each pixel value of the object image to be displayed into a display value.

16. An image displaying apparatus comprising:
an image acquiring unit configured to acquire an object image to be displayed;
a display control unit configured to control a display unit to display the object image to be displayed with a predetermined window level and a predetermined window width; and
a setting unit having a mode in which the predetermined window level and the predetermined window width are both reset through a single operation, and configured to reset the predetermined window level and the predetermined window width; and
wherein, when the object image to be displayed is a display type of an image, a reference value of which is allocated a particular pixel value, the setting unit includes a control unit configured to limit setting of the window level in the mode.

17. The image displaying apparatus according to claim 16, wherein the control unit limits the setting by providing a dead zone of a predetermined range to an input value for setting the window level.

18. The image displaying apparatus according to claim 16, wherein the control unit limits the setting by reducing an input value for setting the window level and receiving the reduced input value.

19. A method of controlling an image displaying apparatus, the method comprising the processes of:
acquiring an object image to be displayed;
determining whether the object image to be displayed is a predetermined display type, a reference value of which is allocated to a particular pixel value;
setting a window level and a window width for displaying the object image to be displayed, and fixing the window level to a predetermined value when the determining process determines that the object image to be displayed is the predetermined display type; and
converting the object image to be displayed so that the object image to be displayed is displayed with the window level fixed to the predetermined value or the set window level and with the set window width.

20. A storage medium storing a computer program configured to cause a computer to execute the processes of the method of controlling an image displaying apparatus according to claim 19.

21. A method of controlling an image displaying apparatus, the method comprising the processes of:
acquiring an object image to be displayed;
controlling a display unit to display the object image to be displayed with a predetermined window level and a predetermined window width; and
resetting the predetermined window level and the predetermined window width,
wherein, when the object image to be displayed is a display type of an image, a reference value of which is allocated a particular pixel value, setting of the window level in the resetting process is limited in a mode in which the predetermined window level and the predetermined window width are both reset through a single operation.

22. A storage medium storing a computer program configured to cause a computer to execute the processes of the method of controlling an image displaying apparatus according to claim 21.

23. An image displaying apparatus comprising:
a receiving unit configured to receive change of a window level and a window width by a user when an object image to be displayed is displayed; and
a changing unit having a mode in which the window level and window width of the object image to be displayed are changed in accordance with the change of the window level and the window width by the user, and a mode in which only the window width of the object image to be displayed is changed in accordance with the change of the window level and the window width by the user.
